(19) United States
(12) Patent Application Publication
(10) Pub. No.: US 2025/0382842 A1
(43) Pub. Date: Dec. 18, 2025

(54) System for screening a fixture

(71) Applicant: Pellini S.p.A., Codogno LO (IT)

(72) Inventors: Giovanni NICOLOSI, Codogno LO (IT); Alessandro PELLINI, Codogno LO (IT); Sergio BIFFI, Codogno LO (IT); Luca PAPAIZ, Codogno LO (IT)

(21) Appl. No.: 18/875,509

(22) PCT Filed: Jun. 14, 2023
(86) PCT No.: PCT/IB2023/056159

§ 371 Date: Dec. 16, 2024

(30) Foreign Application Priority Data
Jun. 20, 2022 (IT) 102022000012928

(51) Int. Cl. E06B 9/322; E06B 9/264

(52) U.S. Cl. CPC E06B 9/322; E06B 9/264; E06B 2009/2646; E06B 2009/3222

(57) ABSTRACT

The present invention concerns a system for screening a fixture, such as a Venetian blind in a double glazing, comprising at least one screening element, and a transmission system connected to it for moving it between different operating positions and causing different levels of screening of the fixture. The transmission system comprises two pulleys and a transmission belt with a toothing for meshing with at least a first pulley. A barrier element, for example a U-shaped or closed profile, is arranged between the pulleys and is interposed between two longitudinal sections of the belt to prevent contact between distinct portions of the toothing of the belt.

### TECHNICAL FIELD

The present invention is developed in the field of the screening of fixtures to regulate the passage of light towards the interior of a building, for example by means of Venetian blinds inside double glazings, in accordance with the preamble of claim 1.

### PRIOR ART

Double glazing systems in which Venetian blinds are housed are known. One of the ways to move the blind, by letting more or less light pass through the double glazing, involves using a belt wound on two pulleys. Two longitudinal sections of the belt extend parallel to each other between the pulleys.

The sliding of the belt places in rotation the pulleys, one of which is connected to the Venetian blind in such a way as to move it, when the pulley rotates. To optimize transmission, the belt and at least one pulley can be toothed.

In a known manner, when the belt is inside the double glazing, a magnetic system allows to drag the belt through a handle (or slider) outside the double glazing.

### Problems of the Background Art

While pulling the handle, a part of the belt is subjected to a relatively high mechanical tension, which causes a partial elastic elongation thereof. Another part of the belt is in a loose condition, and can thus bend into randomly shaped undulations.

The undulations can lead one of the two longitudinal sections of the belt to contact the opposite longitudinal section thus creating a mechanical jam.

In particular, the contact between the toothings of the two sections can hinder the sliding in the opposite direction of the two longitudinal sections of the belt such that noise is generated or the movement of the handle and hence the movement of the blind are even prevented.

This problem is exacerbated when the positioning of the belt is inside the double glazing. In fact, given the limited thickness of the double glazing there is a greater likelihood that mechanical jam can be created.

The increase in the tension of the belt can reduce its undulations, but makes its movement more difficult.

The screening systems made with double glazing are also characterized by a very wide operating range in temperature, starting from winter night operation with temperatures below 0° C., to summer temperatures under direct solar irradiation reaching temperature peaks exceeding 60° C. The belt is therefore subject to strong thermal expansions and contractions that cannot rely on normal tensioning mechanisms since the latter also change their behaviour based on the temperature and add unmanageable frictions in the event of movement of the mechanism through magnets. The possible contraction of the belt in case of cold obliges to choose a nominal length that is greater than necessary in standard conditions, while the expansion of the belt in case of hot situation, further worsens the effect thereof.

Finally, if the inconvenience occurs in the double glazing, there is a risk of having to open the double glazing itself to free the two belt sections and return to normal use.

DE 202008009334 shows a blind in a double glazing. Two profiles are arranged on the sides of the blind to prevent the passage of light along the edges. These profiles are arranged between the two longitudinal sections of the belt. In addition, they have U-shaped recesses at both ends, to house springs that keep the pulleys spaced apart in order to tension the belt.

### SUMMARY OF THE INVENTION

The object of the present invention is to solve the problems set forth with reference to the prior art.

In particular, an object of the invention is to improve the sliding of the belt on the pulleys.

This and other purposes are achieved by a system for screening a fixture according to any one of the appended claims.

### ADVANTAGES OF THE INVENTION

Thanks to the present invention it is possible to obtain a system that provides a barrier element, for example a U-shaped or closed profile, arranged in the longitudinal direction between the two pulleys, and in the transverse direction between the two longitudinal sections of the transmission belt. The barrier element is shaped to prevent contact between different portions of the toothing of the belt, which are placed at the two longitudinal sections of the belt.

Moreover, thanks to the present invention, it is possible to apply the system also to screening systems without double glazings, where there is still a risk of contact between different portions of toothings of the belt.

In addition, thanks to the barrier element, the screening system can also be used for non-vertical fixtures, such as skylights, where the force of gravity represents an additional factor of undulation of the longitudinal sections of the belt.

Further features and advantages of the invention will be recognisable by a person skilled in the art from the following detailed description of exemplary embodiments of the invention.

### BRIEF DESCRIPTION OF THE FIGURES

For a better understanding of the following detailed description, some embodiments of the invention are illustrated in the accompanying drawings, wherein:

FIG. 1 shows a side sectional view of a system for screening the passage of light through a fixture according to the prior art,

FIG. 2 shows a partial side sectional view of a system for screening the passage of light through a fixture according to an embodiment of the invention,

FIG. 3 shows an exploded perspective view of the system of FIG. 1,

FIG. 4 shows a schematic sectional view from above of the system of FIG. 2, and

FIG. 5 shows a schematic sectional view from above of a system for screening the passage of light according to an alternative embodiment of the invention.

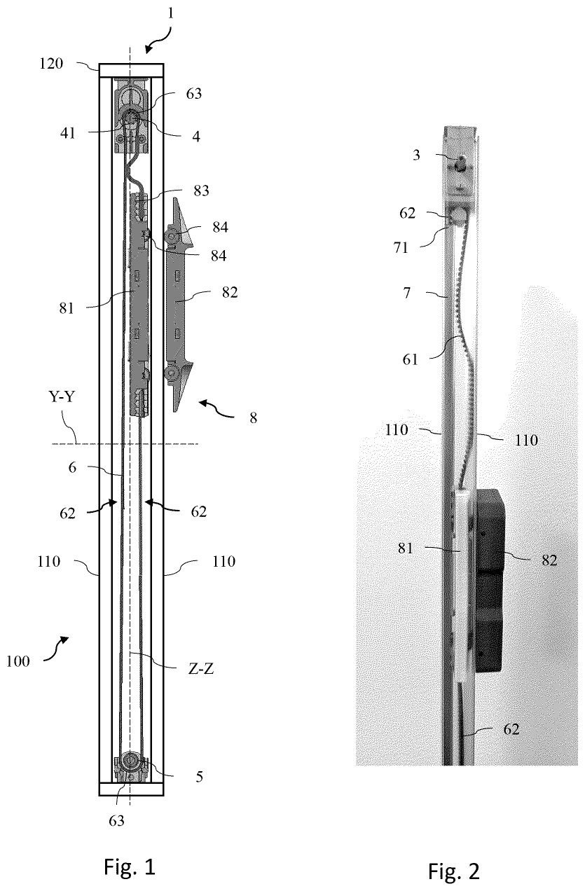

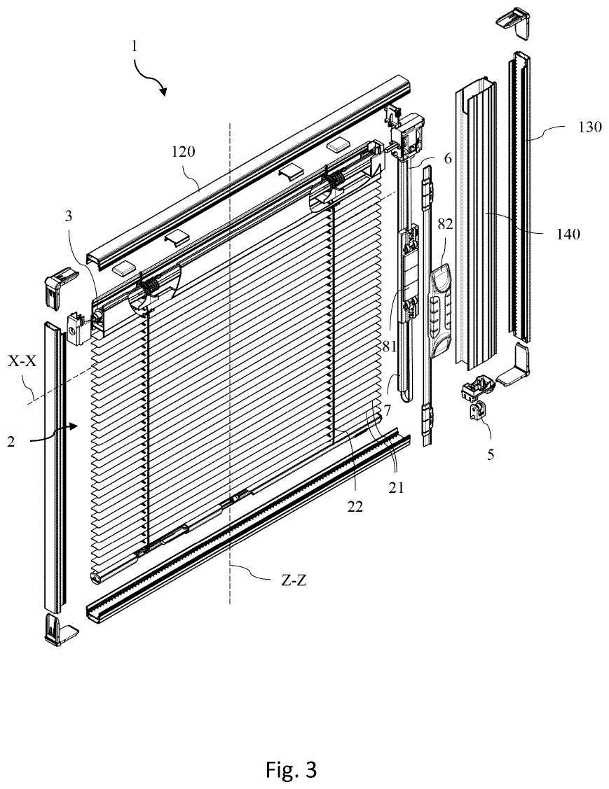

### DETAILED DESCRIPTION

The invention concerns a system 1 for screening the passage of light through a fixture, such as a door or a window.

In the preferred embodiment, the fixture is identified by a double glazing 100, which comprises at least two transparent panels 110, parallel and spaced apart from each other. In addition, the double glazing 100 comprises a frame 120, which connects the panels 110 to each other and is arranged along outer edges of the panels 110. The frame 120 and the panels 110 delimit and seal together an inner volume.

The double glazing 100 may also comprise other components per se known to a person skilled in the art, such as a spacer 130 between the panels 110, and a containment profile 140, for containing components described below, such as at least a portion of a transmission system.

The invention can however also be applied to fixtures with a single transparent, fixed or movable panel such as a sash, or even to fixtures without panels or sashes.

In any case, reference will be made below mainly to a double glazing without thereby losing generality.

The screening system 1 comprises a screening device 2 having one or more screening elements 21.

Preferably, the screening device 2 is arranged in the inner volume of the double glazing 100.

Each screening element 21 is movable between a plurality of operating positions to cause different degrees of screening for the passage of light through the fixture.

In the preferred embodiment, the screening device 2 is a Venetian blind, and the screening elements 21 are slats of the Venetian blind. The slats are arranged parallel and spaced apart from each other. The slats are movable along a longitudinal direction Z-Z, to be distributed along the fixture, to maximize light screening, or retracted into a stack of slats, to maximize the passage of light. The slats are also orientable in such a way as to screen light rays incident on the fixture from different directions.

It is worth noting that, depending on the type of screening element 2, the screening system 1 can be used for fixtures with different spatial orientations, whereby the longitudinal direction Z-Z can be substantially vertical, as illustrated in the figures, but can also be substantially horizontal, or even inclined with other angles.

The screening system 1 comprises a transmission system kinematically connected to each screening element 21 and configured to move each screening element 21 between the different operating positions.

In known manner, the transmission system may comprise one or more pulling cords 22. Each screening element 21 is connected to at least one respective pulling cord 22. For example, the pulling cords 22 may be cords and/or cord ladders of the Venetian blind configured for lifting and/or orienting the slats.

Still in known manner, the transmission system may comprise a rotation shaft 3, rotatable about an axis preferably extending in a width direction X-X of the fixture.

Each pulling cord 22 is wound at least partially around the rotation shaft 3 so as to be laid out, retracted and/or slid, in particular in the longitudinal direction Z-Z, by the rotation of the rotation shaft 3.

The transmission system comprises a first pulley 4 and a second pulley 5, spaced apart from each other in longitudinal direction Z-Z. The first pulley 4 is coupled to the rotation shaft 3 such that the rotation shaft 3 is placed in rotation by the rotation of the first pulley 4. For example, the first pulley 4 may be fixed to the rotation shaft 3, or coupled to the rotation shaft 3 by means of gears.

Instead, the second pulley 5 is preferably a free pulley, rotatable for example on a rotation pin.

Furthermore, the transmission system comprises a transmission belt 6 slidably mounted on the first and second pulley 4, 5, so as to place in rotation the first and second pulley 4, 5 by sliding the belt 6. In particular, the belt 6 is wound at least partly on the first and second pulley 4, 5, for example half a turn on the first pulley 4 and half a turn on the second pulley 5.

The belt 6 is arranged with two longitudinal sections 62 parallel to each other. The longitudinal sections 62 extend mainly in the longitudinal direction Z-Z, from the first pulley 5 to the second pulley 6. Further, the longitudinal portions 62 are spaced apart from each other in a transverse direction Y-Y, transverse to the longitudinal direction Z-Z. Preferably, the transverse direction Y-Y is perpendicular to the width direction X-X, and thus represents a thickness direction of the double glazing 100. However, in some embodiments the transverse direction Y-Y may coincide with the width direction X-X, for example when the first pulley 4 is connected to the shaft 3 by means of a bevel gear.

The two longitudinal sections 62 are connected to each other by wound sections 63 of the belt 6. At each wound section 63, the belt 6 is in contact with the first or second pulley 4, 5.

It is worth noting that the sliding of the belt 6 with respect to the pulleys 4, 5 causes a displacement of each part of the belt 6, whereby different portions of the belt 6 will identify each time the longitudinal sections 62 and the wound sections 63 of the belt 6. Furthermore, during sliding it is possible that at least a part of the belt 6 gets loose and bends, deviating from the straight course of the longitudinal sections 62 when they are in a rest condition.

The belt 6 preferably has an inner surface and an opposite outer surface. Different portions of the inner surface are oriented towards each other at the longitudinal sections 62. Furthermore, still different portions of the inner surface are turned towards the first and second pulley 4, 5 at the wound sections 63.

The first pulley 4 has a toothing 41, placed on a circular surface of the pulley 4. The belt 6 also has its own toothing 61, configured to mesh with the toothing 41 of the first pulley 4. The second pulley 5 may or may not provide a further toothing (not illustrated), configured to mesh with the toothing 61 of the belt 6.

The toothing 61 of the belt 6 is positioned on the inner surface of the belt 6. The toothing 61 may extend over the entire length of the belt 6, or only over a portion of the belt 6. It is understood, however, that the toothing 61 of the belt 6 extends at least at the first pulley 4, on the respective wound section 63 of the belt 6. Furthermore, the toothing 61 of the belt 6 extends at least in part along one or both of the longitudinal sections 62. Following the sliding of the belt 6 in order to bring each screening element 21 between the different operating positions, different portions of the toothing 61 of the belt 6 will be situated from time to time in the wound section 63 at the first pulley 4.

According to a peculiar aspect of the present disclosure, a barrier element 7 is arranged, in the transverse direction Y-Y, at a predetermined position between the two longitudinal sections 62 of the belt 6, for example halfway between the longitudinal sections 62.

The barrier element 7 is shaped to prevent contact between distinct portions of the toothing 61 of the belt 6, which are placed at the two longitudinal sections 62.

In other words, the barrier element 7 acts as a dividing septum interposed between the two longitudinal sections 62 of the belt 6 so as to prevent their physical contact, i.e. it partitions the volume in which the two longitudinal sections 62 of the belt 6 are housed so as to avoid mechanical jams of the respective toothings.

For this purpose, the barrier element 7 is arranged in the longitudinal direction Z-Z at a predetermined position between the first pulley 4 and the second pulley 5. More in detail, the barrier element 7 has a linear development substantially parallel to the longitudinal sections 62 of the belt 6.

The barrier element 7 extends mainly in the longitudinal direction Z-Z and has a first end 71 and a second end 72 spaced apart from each other in the longitudinal direction Z-Z. The first end 71 is proximal to the first pulley 4, and the second end 72 is proximal to the second pulley 5.

Preferably, the barrier element 7 has the maximum possible longitudinal extension without touching the first and second pulley 4, 5, so as not to hinder their rotation. For example, a length of the barrier element 7 in the longitudinal direction Z-Z is equal to at least 80%, or in any case at least to 50%, of a length in the longitudinal direction Z-Z of each of the longitudinal sections 62 of the sliding path 7.

The barrier element 7 is mounted so as to occupy the described position in the longitudinal Z-Z and transverse Y-Y directions in a fixed manner. In particular, the barrier element 7 can be fixed to the double glazing 100, for example to the panels 110 or to the frame 120, and/or in any case to the fixture or to a wall in which the fixture is installed.

Preferably, the barrier element 7 has a width, in the width direction X-X, at least equal to a width in the width direction X-X of the belt 6.

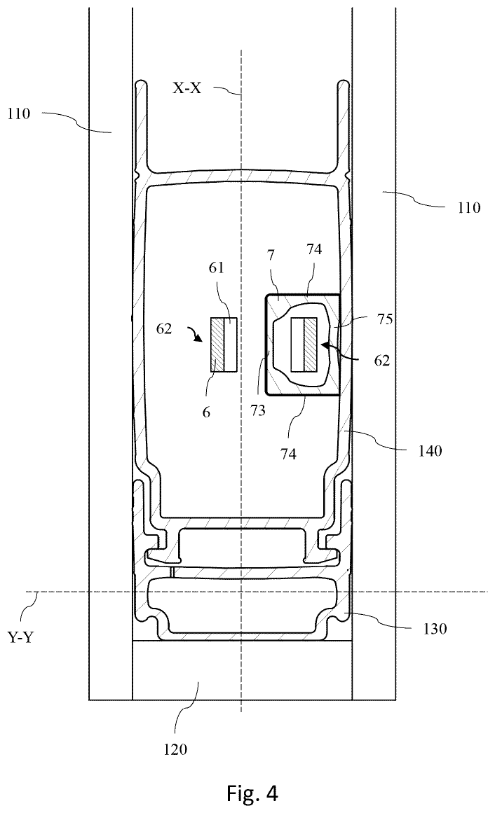

In the preferred embodiment, the barrier element 7 is a profile, in particular with a substantially U-shaped or closed section (as shown in FIG. 4), considering a section perpendicular to the longitudinal direction Z-Z, i.e. the barrier element 7 is shaped like a cable duct. More in detail, the barrier element 7 has a base portion 73 and two side portions 74 protruding from the base portion 73, preferably transversely to the base portion 73.

The base portion 73 extends from the first to the second end 71, 72, and is preferably positioned between the two longitudinal sections 62 of the sliding path 7. Therefore, it is primarily the base portion that prevents contact between the different portions of the toothing 61 of the belt 6.

The two side portions 74 are spaced apart from each other, in the preferred embodiment in the width direction X-X. Each side portion 74 extends from the first to the second end 71, 72. One of the longitudinal sections 62 of the sliding path 7 is located between the two side portions 74.

In this way, the barrier element 7 not only prevents jams between toothings 61 of different portions of the transmission belt 6, but identifies a compartment in which one of its longitudinal sections 72 is insertable. Said longitudinal section 72 is therefore limited in movement also in the width direction X-X, when the transmission belt 6 thermally expands. This prevents derailments of the transmission belt 6 from the pulleys 4, 5. The other longitudinal section 72 of the belt is instead outside the compartment.

In case of closed section, the barrier element 7 also has a closing portion 75, spaced from the base portion 73 and connected to the side portions 74. A longitudinal portion 62 of the belt 6 extends at least partly within an inner space surrounded by the base portion 73, the closing portion 75 and the side portions 74.

In other embodiments, the barrier element 7 may have an H-section, and both longitudinal sections 62 may be found between side portions 74. Or, the barrier element 7 may have an E-section, with three side portions 74. In such a case, it is preferably one of the side portions 74 that can be found between the longitudinal sections 62 to prevent contact thereof, and not the base portion 73.

Barrier elements 7 with closed section guarantee the maximum positioning stability of the transmission belt 6. Barrier elements 7 with open section facilitate the insertion of the transmission belt 6 into the compartment of the barrier element 7. Positioning stability can however be maximized if another element of the system 1, such as a portion of the panel 110, of the frame 120 or of the containment profile 140, is facing, preferably in contact with or close to, the free ends of the side portions 74.

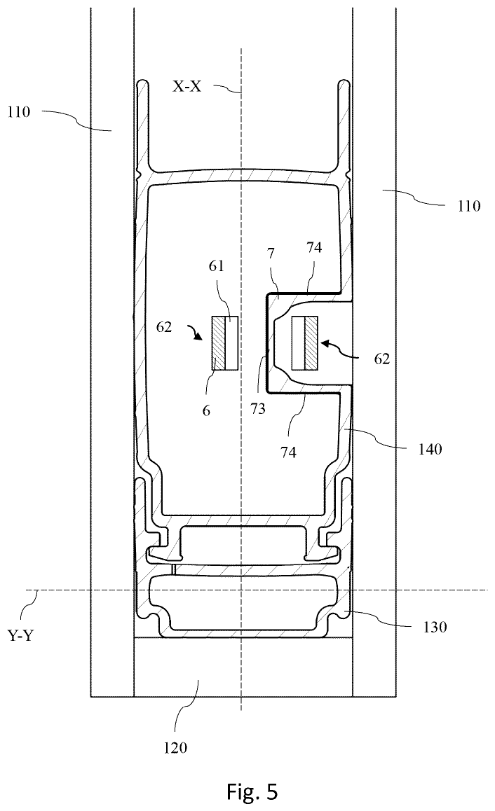

In still an embodiment, the barrier element 7 is formed in one piece with the containment profile 140, which contains the entire transmission belt 6, as shown in FIG. 5, or is formed as one piece in the frame 120. Alternatively, the barrier element 7 may be fixed to the containment profile 140 or to the frame 120.

In the embodiment with the screening device 2 inside the double glazing 100, preferably also each pulling cord 22, the rotation shaft 3, the first pulley 4, the second pulley 5, the belt 6, and the barrier element 7 are arranged in the inner volume of the double glazing 100.

In order to move the belt 6, and therefore indirectly each screening element 21, the transmission system may comprise a handle system 8. In the absence of the double glazing 100, the handle system 8 may be simply a handle fixed to the belt 6, or no handle system 8 may be provided, the belt 6 being directly graspable by a user.

In the presence of the double glazing 100, preferably the handle system 8 comprises a first element 81 arranged in the inner volume of the double glazing 100, and a second element 82 arranged outside the inner volume.

More in detail, the first element 81 is connected to the belt 6 at a first of the longitudinal sections 62 of the sliding path 7. In the illustrated embodiment, for this purpose the first element 81 of the handle system 8 has a toothing 83 configured to mesh with the toothing 61 of the belt 6.

The first element 81 is movable together with a portion of the belt 6 in the longitudinal direction Z-Z, between the first and second pulley 4, 5. It is worth noting that the first of the longitudinal sections 62, where the first element 81 of the handle system 8 is positioned, is preferably not the longitudinal section 62 that is located between the side portions 74 of the barrier element 7.

The second element 82 has a portion graspable by a user and is movable along a panel 110 of the double glazing 100 in the longitudinal direction Z-Z.

The first element 81 and the second element 82 of the handle system 8 comprise respective magnets (not illustrated) and are magnetically coupled to each other. Thanks to the magnetic coupling, under normal conditions of use the first and second element 81, 82 are aligned with each other in the thickness direction Y-Y. Therefore, the dragging of the second element 82 by the user causes the sliding also of the first element 81, and therewith of the entire belt 6, ultimately causing the movement of the screening elements 21.

Optionally, the first and second element 81, 82 of the handle system 8 comprise wheels 84 for sliding along opposite faces of a same panel 110 of the double glazing 100.

Optionally, the barrier element 7 has a guide portion (not illustrated), and the first element 81 of the handle system 8 is slidable in the longitudinal direction Z-Z along the guide portion.

In an alternative embodiment, instead of the handle system 8, the screening system 1 may comprise an electric motor (not illustrated) connected to the first or second pulley 4, 5. The electric motor is operable to be rotated, causing also rotation of the pulley 4, 5 to which it is connected, and thus causing the sliding of the belt 6.

For example, in the embodiment in which the Venetian blind is present, the electric motor can be connected to the second pulley 5, the belt 6 being provided to transfer the motion from the second pulley 5 to the first pulley 4 and thus to the rotation shaft 3. Other embodiments of the screening device 2 may also provide the electric motor connected to the first pulley 4.

Obviously a person skilled in the art will be able to make numerous equivalent modifications to the variants set forth above, without thereby departing from the scope of protection as defined by the appended claims.

1. System for screening a fixture, comprising:
at least one screening element, movable between a plurality of operating positions to cause different degrees of screening for the passage of light through a fixture,
a transmission system kinematically connected to the at least one screening element and configured to move the at least one screening element between said operating positions,
wherein the transmission system comprises:
a first and a second pulley spaced apart from each other in a longitudinal direction, and
a transmission belt slidably mounted on the first and second pulley,
wherein:
the first pulley and the belt have respective toothings configured to mesh with each other,
the belt is arranged with two longitudinal sections parallel to each other, which extend from the first to the second pulley and are spaced apart from each other in a transverse direction, transverse to the longitudinal direction,
a barrier element occupies, in the longitudinal direction, a fixed position between the first and second pulley, and, in the transverse direction, a fixed position between the two longitudinal sections of the belt, the barrier element being shaped to prevent contacts between distinct portions of the toothing of the belt, which are placed at the two distinct longitudinal sections,
the barrier element is a profile having a base portion and two side portions protruding from the base portion, wherein the base portion or at least one of the side portions is placed between the two longitudinal sections of the belt,
wherein:
at least one of the longitudinal sections of the belt is located between the two side portions of the barrier element.

2. System according to claim 1, wherein the barrier element identifies a compartment in which one of the longitudinal sections of the belt is insertable.

3. System according to claim 1, comprising a double glazing, wherein:
the double glazing comprises at least two transparent panels, parallel and spaced apart from each other, and a frame which connects the panels to each other, wherein the frame and the panels together delimit an inner volume,
the at least one screening element, the first and second pulley, the belt and the barrier element are arranged in the inner volume.

4. System according to claim 3, wherein:
the barrier element is formed as one piece with the frame, or
a containment profile contains the entire transmission belt, and the barrier element is formed as one piece with the containment profile.

5. System according to claim 3, wherein:
the transmission system comprises a handle system, comprising a first element connected to the belt at one of said longitudinal sections, and a second element arranged outside the inner volume, magnetically coupled to the first element and draggable to slide the belt.

6. System according to claim 5, wherein the first element of the handle system has a toothing configured to mesh with the toothing of the belt.

7. System according to any one of claim 1, comprising an electric motor 10 connected to the first or second pulley in such a way as to cause the sliding of the belt when the motor is placed in rotation.

8. System according to any one of claim 1, wherein the barrier element extends mainly in the longitudinal direction and has a first end proximal to the first pulley, and a second end proximal to the second pulley.

9. System according to any one of claim 1, wherein the barrier element has a linear development substantially parallel to the longitudinal sections of the belt.

10. System according to any one of claim 1, wherein a length of the barrier element in the longitudinal direction is equal to at least 50%, preferably at least 80%, of a length in the longitudinal direction of each of the longitudinal sections of the belt.

11. System according to any one of claim 1, wherein the barrier element has a width, in a width direction perpendicular to the longitudinal direction and to the transverse direction, at least equal to a width in the width direction of the belt.

12. System according to any one of claim 1, wherein the barrier element has a closed section, having a closing portion spaced from the base portion and connected to the side portions.

13. System, according to any one of claim 1, wherein the transmission system comprises a rotation shaft and at least one pulling cord at least partially wound around the rotation shaft, wherein the at least one screening element is connected to the at least one pulling cord, and the first pulley is coupled to the rotation shaft.

14. System according to any one of claim 1, comprising a Venetian blind having a plurality of slats, wherein each screening element is a slat of the Venetian blind.

15. Double glazing comprising:
at least two transparent panels, parallel and spaced apart from each other,
a frame, which connects said at least two panels to each other and is arranged along outer edges of said at least two panels;
said frame and said at least two panels delimit and seal together an inner volume;
a system for screening a fixture according to claim 1.
